(19) United States
(12) Patent Application Publication
(10) Pub. No.: US 2008/0138057 A1
(43) Pub. Date: Jun. 12, 2008

(54) Masking and unmasking method for a digital still camera

(76) Inventor: Feng-Hsing Wang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/657,002

(22) Filed: Jan. 24, 2007

(30) Foreign Application Priority Data
Dec. 8, 2006 (TW) 95146048

(51) Int. Cl. G03B 17/24

(52) U.S. Cl. 396/311

(57) ABSTRACT

A masking and unmasking method for a digital still camera directly defines at least one masking area on the image data that is executed with a masking process in a digital still camera. The image data that has been masked can be recovered. Thereby, the inconvenience caused by the need to use an additional application software in a computer to process the image data of the prior art is overcome.

### BACKGROUND OF THE INVENTION

1. Field of the Invention

The present invention relates to a digital still camera. In particular, this invention relates to a masking and unmasking method for a digital still camera.

2. Description of the Related Art

When someone takes a picture of controversial objects and the photo is not specially processed, such as masking the controversial objects in the picture, the viewer is often offended.

In order to overcome this, after a user takes pictures, and the image data has been taken from the photography device and transferred to a computer, the user uses an application software stored in the computer to process the picture, such as adding a special feature to cover the controversial part of the picture. Therefore, viewers will not be offended when they view the pictures.

However, although the user can use the application software in the computer to process part of the pictured image data to cover the controversial parts of the picture, it is still inconvenient for the user. When the user takes such a picture, the user cannot process it and show it to a viewer immediately.

### SUMMARY OF THE INVENTION

One particular aspect of the present invention is to provide a masking and unmasking method for a digital still camera. The method directly defines at least one masking area on the image data that will be masked in the digital still camera to execute the masking process, and recovers the image data that has been masked. Thereby, the problem of the prior art, such as the inconvenience caused to the user by having to use the application software in the computer to process part of the pictured image data to cover the controversial part of the picture, is overcome.

In a first embodiment of the masking method for a digital still camera of the present invention, the user first selects the image data that needs to be masked and displays it on the monitor. Next, the user selects an item for adding a mask from the functional menu. At this time, the user controls the dimensions and the location of a selected block that is displayed on the monitor to define a masking area on the image data.

Finally, the digital still camera masks a defined masking area. When the digital still camera executes the masking process, the average value of a plurality of image pixels in the masking area is obtained, and is filled to each of the image pixels to cover the original image. Alternatively, the masking area is divided into a plurality of image blocks, and the image blocks are rearranged to achieve the covering effect.

In a second embodiment of the masking method for a digital still camera of the present invention, the user first selects an image that needs to be masked and displays it on the monitor. Next, the user selects an item for adding a mask from the functional menu. At this time, the user controls the dimensions and the location of a selected block that is displayed on the monitor to define a masking area on the image data that will be masked.

Finally, before the digital still camera executes a masking process on the defined masking area, the user must input a security code to make the digital still camera execute a masking process according to the security code. When the digital still camera executes a masking process, the masking area is divided into a plurality of image blocks, and the image blocks are rearranged according to the security code to achieve the covering effect. Furthermore, the original coordinates of the masking area and the length and the width of the image block are recorded in a column of the image data file so that the digital still camera can execute the unmasking process hereafter.

In a second embodiment of the unmasking method for a digital still camera of the present invention, the user first selects image data that needs to be executed an unmasking process, and displays it on the monitor. Next, the user clicks a functional menu for executing an unmasking process from the functional menu. At this time, the user inputs the security code to make the digital still camera recover each of the image blocks to its original location. Furthermore, when the digital still camera finishes the unmasking process, the recorded original coordinates of the masking area and the length and the width of the image block are deleted.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a flow chart of the masking method for a digital still camera of the first embodiment of the present invention;

FIG. 2 is a flow chart of the masking method for a digital still camera of the second embodiment of the present invention; and

FIG. 3 is a flow chart of the unmasking method for a digital still camera of the second embodiment of the present invention.

### DETAILED DESCRIPTION OF THE PREFERRED EMBODIMENTS

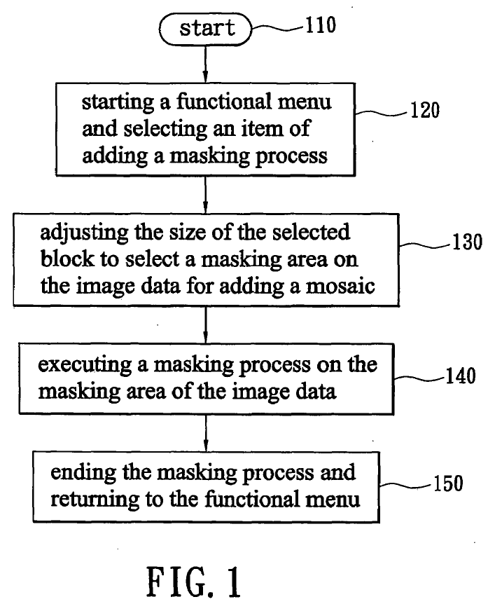

Reference is made to FIG. 1, which shows a flow chart of the masking method for a digital still camera of the first embodiment of the present invention. A masking process is executed on image data of controversial objects taken by a digital still camera.

After a user takes a picture, the image source is processed and stored in an external memory so that the user can view the image source thereafter.

First, the user selects an image source that needs to be masked from the plurality of image sources in the external memory, and displays the selected image source on the monitor of the digital still camera, S110.

Next, the user starts a functional menu provided by the digital still camera and displays it on the monitor of the digital still camera. The functional menu includes a plurality of items. Therefore, the user clicks and selects an item for executing a masking process from the functional menu displayed on the monitor via a functional button located on the digital still camera, S120.

When the user clicks and selects an item for executing a masking process, the digital still camera uses an application software stored in the digital still camera to drive the monitor to display a selected block with a predetermined dimensions and a location. At this time, the user controls the dimensions and the location of the selected block to select part of the image data to define a masking area on the image data that will be masked via a functional button, S130. The shape of the masking area can be square, circular, or irregular.

After the masking area on the image data is defined, the user uses a button control unit to make the digital still camera execute the masking process on the masking area, S140. If the user still wants to select other masking areas, the steps 130 and 140 are repeated until all masking areas are selected.

When the digital still camera executes the masking process, the average value of a plurality of image pixels in the masking area is obtained, and is filled to each of the image pixels to cover the original image. Alternatively, when the masking process is executed, the image blocks can be randomly disposed to achieve the covering effect. In other words, the masking area is divided into a plurality of image blocks, and the image blocks are rearranged.

The present invention mainly uses the method of randomly disposing the image blocks to achieve the covering effect. Because the user can adjust the size of the image blocks when the user uses the method of randomly disposing the image blocks. When the size of each image block is big, the covering effect worsens. When the size of each image block is small, the covering effect improves.

When the digital still camera finishes all the masking processes on the masking areas defined by the user, the masking process ends, and the method returns to the functional menu so that the user can select the next item, S150.

When the masking method for a digital still camera of the present invention uses the average value of the image pixels to replace each of the image pixels, the masking process cannot be reversely executed. This means that when the controversial objects on the image data are covered, the image data on the masking area cannot be recovered. Therefore, when the user wishes to recover the image data that has been masked, the image data must be recorded before the masking process is executed.

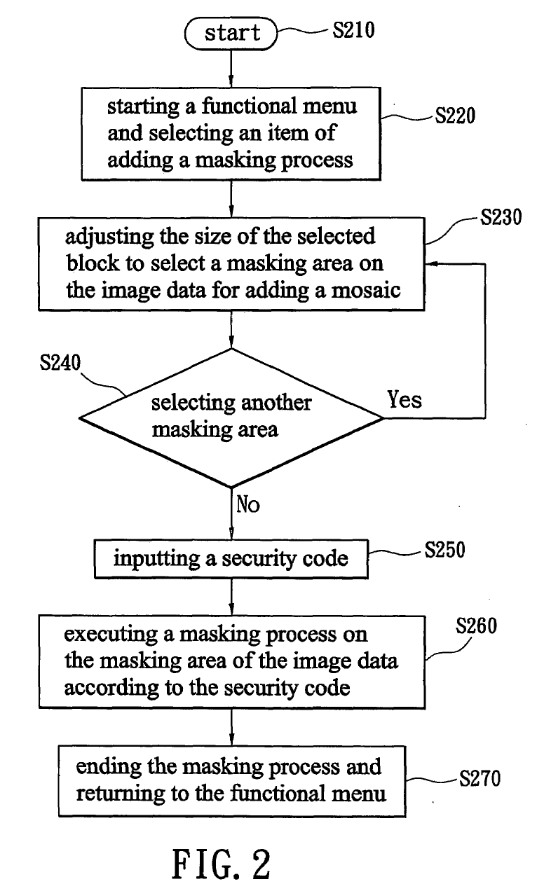

Reference is made to FIG. 2, which shows a flow chart of the masking method for a digital still camera of the second embodiment of the present invention. A masking process is executed on image data of controversial objects taken by a digital still camera and the masked image data can be recovered.

First, the user selects an image source that needs to be masked from the plurality of image sources in the external memory, and displays the selected image source on the monitor of the digital still camera, S210.

Next, the user starts a functional menu provided by the digital still camera and displays it on the monitor of the digital still camera. The functional menu includes a plurality of items. Therefore, the user clicks and selects an item for executing a masking process from the functional menu displayed on the monitor via a functional button located on the digital still camera, S220.

When the user clicks and selects an item for executing a masking process, the digital still camera uses an application software stored in the digital still camera to drive the monitor to display a selected block with a predetermined dimensions and a location. At this time, the user controls the dimensions and the location of the selected block to select part of the image data to define a masking area on the image data that will be masked via a functional button, S230.

After the masking area on the image data is defined, the digital still camera determines whether the user selects a next masking area or not, S240.

When the user wishes to select the next masking area, S230 and S240 are repeated until all the masking areas are selected.

After the user selects all of the masking areas, the user selects the next process via the functional button on the digital still camera-requesting the user to input a security code defined by the user, S250.

An embodiment of inputting a security code is implemented by the up, down, left, and right buttons of the functional buttons. For example, the security code can be set by the order and number of times of pressing the up, down, left, and right buttons. The prerequisite is that figures and characters represented by the up, down, left, and right buttons have to be defined in advance.

Alternatively, another embodiment of inputting a security code is implemented by selecting at least one character defined by the user from the string list displayed on the monitor via the functional buttons.

When the user inputs the security code to the digital still camera, the security code is processed by the digital still camera to form a reference value. Therefore, the digital still camera can compare the reference value with random table stored in the digital still camera, and execute the masking process on the masking area of the image data according to the comparing result, S260.

In the second embodiment, the masking process is executed by randomly disposing the image blocks. In other words, the masking area of the image data is divided into a plurality of image blocks, and the image blocks are rearranged according the comparing result between the reference value and the random table.

After the masking process is executed on the selected masking area of the image data, the digital still camera further utilizes a changeable file format technology to record the original coordinates of the masking area and the length and the width of the image block are recorded in a column of the image data file so that the digital still camera can execute the unmasking process hereafter.

When the digital still camera has finished all the masking processes on the masking areas defined by the user, the masking process ends, and the method returns to the functional menu so that the user can select the next function item, S270.

The masking process of randomly disposing the image locks is a reverse process. Even though the controversial objects have been masked, the masking areas can be recovered by inputting the original security code.

Although the security code can be generated by pressing the up, down, left, and right buttons, it is not limited to the method described above. Using any control buttons on the digital still camera that can be converted into figures and characters is within the scope of the present invention.

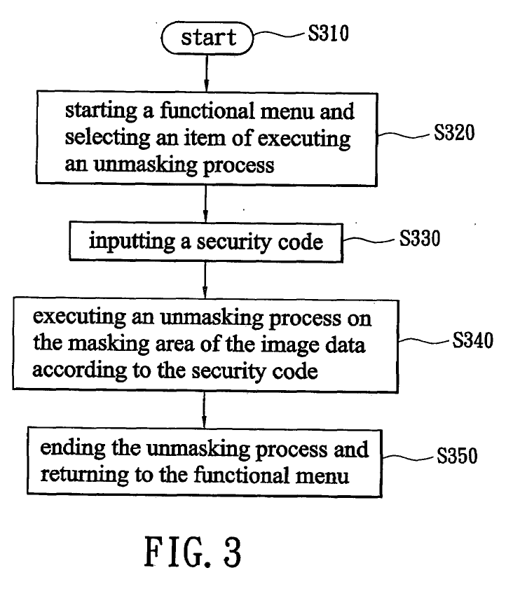

Reference is made to FIG. 3, which shows a flow chart of the unmasking method for a digital still camera of the second embodiment of the present invention. It illustrates how to recover the image data that has been masked.

First, the user selects image data that has been masked from the plurality of image sources in the external memory, and displays it on the monitor of the digital still camera for executing an unmasking process, S310.

Next, the user starts a functional menu provided by the digital still camera and displays it on the monitor of the digital still camera. The functional menu includes a plurality of items. Therefore, the user clicks and selects an item for executing an unmasking process from the functional menu displayed on the monitor via a functional button located on the digital still camera, S320.

When the user clicks and selects the item for executing an unmasking process, the digital still camera uses an application software stored in the digital still camera to display a request on the monitor to request the user to input the security code used in the masking process, S330. At this time, the user must follow the request displayed on the monitor to input a security code to the digital still camera. The digital still camera executes the unmasking process on all the masking areas of the image data according to the security code inputted by the user, S340.

The second embodiment uses the method of randomly disposing the image blocks to execute the masking process on the masking areas, and records the original coordinates of the masking areas and the length and the width of the image blocks in a column of the image data file when the masking process is executed. Therefore, when the unmasking process is executed, the security code is processed by the digital still camera to form a reference value. The digital still camera can compare the reference value with a random table stored in the digital still camera, and execute the unmasking process on the selected masking areas of the image data according to the comparing result and the original coordinates of the masking areas and the length and the width of the image blocks.

When the digital still camera has finished all the unmasking processes on the masking areas defined by the user, the unmasking process ends, and the method returns to the functional menu so that the user can select the next function option, S350.

If the masking area that has been executed with the unmasking process is different from the original one (the recovered image data is different from the image data that has not been masked), this means that the inputted security code is wrong. Therefore, step S310 is repeated until the user inputs the correct security code.

Although inputting a security code, selecting a masking area, and providing a control instruction can be implemented by the control buttons on the digital still camera, the present invention is not limited to the method described above. Whatever means for inputting a security code is used, selecting a masking area, and providing a control instruction is within the scope of the present invention. Therefore, when the monitor of the digital still camera is a touch panel, the user can finish the operations, including inputting a security code, selecting a masking area, and providing a control instruction, by touching the monitor.

Furthermore, when the digital still camera finishes the unmasking process, the relative data stored in the image data file is deleted.

An advantage of the present invention is that the user can directly execute a masking process or an unmasking process on the image data in the digital still camera.

Another advantage of the present invention is that the user can input a security code to make the digital still camera execute the masking process and the unmasking process according to the security code.

A further advantage of the present invention is that the inputted security code is processed to form a reference value. The reference value is compared with a random table stored in the digital still camera. The digital still camera executes the masking process and the unmasking process according to the comparing result.

A further advantage of the present invention is that the original coordinates of the masking area and the length and the width of the image block are recorded in a column of the image data file when the digital still camera executes the masking process so that the digital still camera can execute the unmasking process hereafter.

A further advantage of the present invention is that the user uses the control buttons on the digital still camera to provide a control instruction, select a masking area, and input a security code.

A further advantage of the present invention is that the user touches the monitor of the digital still camera to provide a control instruction, select a masking area, and input a security code.

A further advantage of the present invention is that the user can determine the size of the image blocks when the masking process is implemented by randomly disposing the image blocks.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A masking method for a digital still camera, which selects an image data from a plurality of image data in a digital still camera for executing a masking process, the steps comprising:
selecting an item of adding a mask from a functional menu;
executing the item of adding a mask, and defining a masking area on the selected image data; and
executing the masking process on the masking area.

2. The masking method for a digital still camera as claimed in claim 1, wherein the step of defining a masking area displays a selected block and dimensions and a location of the selected block are adjusted by a user when the item of adding a mask is executed.

3. The masking method for a digital still camera as claimed in claim 2, wherein shape of the selected block is square, circular, or irregular.

4. The masking method for a digital still camera as claimed in claim 1, wherein the step of defining a masking area is implemented by touching a monitor of the digital still camera, or by using a button control unit on the digital still camera.

5. The masking method for a digital still camera as claimed in claim 1, wherein the step of executing a masking process is implemented by dividing the masking area into a plurality of image blocks, and rearranging each of the image blocks.

6. The masking method for a digital still camera as claimed in claim 1, wherein the step of executing a masking process is implemented by obtaining a pixel value of each image pixel on the masking area, averaging the pixel values to generate an average value, and updating the average value to each of the image pixels.

7. A masking method for a digital still camera, which selects image data from a plurality of image data in a digital still camera for executing a masking process, the steps comprising:
selecting an item of adding a mask from a functional menu;
executing the item of adding a mask, and defining a masking area on the selected image data; and
inputting a security code to the digital still camera for executing a masking process on the masking area.

8. The masking method for a digital still camera as claimed in claim 7, wherein the step of defining a masking area displays a selected block and dimensions and a location of the selected block are adjusted by a user when the item of adding a mask is executed.

9. The masking method for a digital still camera as claimed in claim 8, wherein shape of the selected block is square, circular, or irregular.

10. The masking method for a digital still camera as claimed in claim 7, wherein the step of defining a masking area is implemented by touching a monitor of the digital still camera, or by using a button control unit on the digital still camera.

11. The masking method for a digital still camera as claimed in claim 7, wherein the step of inputting a security code is implemented by touching a monitor of the digital still camera, or by using a button control unit on the digital still camera.

12. The masking method for a digital still camera as claimed in claim 11, wherein the step of touching a monitor of the digital still camera to input a security code further comprises a step of displaying a string list on the monitor, and clicking at least one character from the string list to form the security code.

13. The masking method for a digital still camera as claimed in claim 11, wherein the step of using a button control unit on the digital still camera to input a security code further comprises a step of displaying a string list on the monitor, and clicking at least one character from the string list by using the button control unit to form the security code.

14. The masking method for a digital still camera as claimed in claim 13, further comprising a step of forming the security code according to an order and number of times at least one control button of the button control unit is pressed.

15. The masking method for a digital still camera as claimed in claim 7, wherein the security code is processed to form a reference value, and the reference value is compared with a random table to determine allocation of each image block in the masking area.

16. The masking method for a digital still camera as claimed in claim 7, wherein the step of executing a masking process is implemented by dividing the masking area into a plurality of image blocks, and rearranging each of the image blocks.

17. The masking method for a digital still camera as claimed in claim 16, wherein the allocation of each image block is determined by the security code.

18. The masking method for a digital still camera as claimed in claim 16, further comprising recording a coordinate, a length and a width of each image block in a column of an image data file.

19. The masking method for a digital still camera as claimed in claim 7, further comprising utilizing exchangeable file format technology to record data when the masking area is executed a masking process.

20. An unmasking method for a digital still camera, which selects image data that has been masked from image data in a digital still camera for executing an unmasking process, the steps comprising:
selecting an item of executing an unmasking process from a functional menu;
executing the item of executing an unmasking process to request a user to input a security code; and
judging whether the security code is correct or not to determine whether the unmasking process is executed on at least one masking area of the image data.

21. The masking method for a digital still camera as claimed in claim 20, wherein the step of inputting the security code is implemented by touching a monitor of the digital still camera, or by using a button control unit on the digital still camera.

22. The masking method for a digital still camera as claimed in claim 21, wherein the step of touching a monitor of the digital still camera to input the security code is implemented by clicking at least one character from a string list displayed on the monitor.

23. The masking method for a digital still camera as claimed in claim 20, wherein the step of using a button control unit on the digital still camera to input a security code further comprises a step of forming the security code according to an order and a number of times at least one control button of the button control unit is pressed.

24. The masking method for a digital still camera as claimed in claim 23, wherein the security code is implemented by clicking at least one character from a string list displayed on the monitor via the button control unit.

25. The masking method for a digital still camera as claimed in claim 20, wherein the security code is processed to form a reference value, and the reference value is compared with a random table to determine allocation of each image block in the unmasking process.

26. The masking method for a digital still camera as claimed in claim 20, wherein the masking area includes a plurality of image blocks, and a location of each image block is recovered in the unmasking process.

27. The masking method for a digital still camera as claimed in claim 26, wherein allocation of each image block is determined by the security code.

28. The masking method for a digital still camera as claimed in claim 26, wherein the image data file includes a coordinate, a length, and a width of each image block.

29. The masking method for a digital still camera as claimed in claim 28, further comprising a step of deleting the coordinate, the length, and the width of all image blocks when the unmasking process is finished.

30. The masking method for a digital still camera as claimed in claim 26, further comprising a step of utilizing the coordinate, the length, and the width of all image blocks to recover each image block to its original location.
